(19) United States
(12) Patent Application Publication
(10) Pub. No.: US 2021/0260743 A1
(43) Pub. Date: Aug. 26, 2021

(54) Parallel Jaws Locking Wrench/Plier

(71) Applicant: Kin-Wai Yeung, Sugar Land, TX (US)

(72) Inventor: Kin-Wai Yeung, Sugar Land, TX (US)

(21) Appl. No.: 16/802,550

(22) Filed: Feb. 26, 2020

(51) Int. Cl. B25F 1/00; B25F 1/04

(52) U.S. Cl. CPC B25F 1/003; B25F 1/04

(57) ABSTRACT

An improved parallel-jaws locking wrench/plier with toggle action includes a body element, a fixed jaw, and a moving jaw capable of moving rectilinearly by means of an action cam, which is pivotally connected to a locking lever coupling respectively to the upper ends of a fulcrum bar and a releasing lever thereof. A handle secured to the body element has an axially adjustable screw to regulate the opening of the jaws. This is the chosen embodiment to develop this invention, which enables the toggle wrench/pliers to use interchangeable jaw sets with simple and convenient steps.

### CROSS-REFERENCE TO RELATED APPLICATIONS

This application claims the benefit of provisional patent application Ser. No. 62/811,542, filed 2019 Feb. 28 by the present inventor.

### BACKGROUND

### Prior Art

The following is a tabulation of some prior art that presently appears relevant:

### U.S. Patents

| Pat. No. | Kind Code | Issue Date | Patentee |
|---|---|---|---|
| 1,086,078 | A | 1914 Feb. 3 | Palmer |
| 1,489,458 | A | 1924 Apr. 8 | Petersen |
| 2,399,454 | A | 1946 Apr. 30 | Snell |
| 2,417,013 | A | 1947 Mar. 4 | Petersen |
| 2,481,866 | A | 1949 Sep. 13 | Petersen |
| 2,489,895 | A | 1949 Nov. 29 | Kash |
| 2,519,630 | A | 1950 Aug. 22 | Boyer |
| 2,679,779 | A | 1951 Nov. 26 | Spikings |
| 3,195,382 | A | 1965 Jul. 20 | Rommel et al |
| 3,608,405 | A | 1971 Sep. 28 | Schmidt |
| 4,094,215 | A | 1978 Jun. 13 | Hudson |
| 5,644,960 | A | 1997 Jul. 8 | O'Brien |
| 2011/0,107,880 | A1 | 2011 May 12 | Stucky |

### BACKGROUND

### Prior Art

Toggle link hand tools have been in operation for a long time since Apr. 8, 1924 when William Petersen was granted U.S. Pat. No. 1,489,458, to be more specific, this is the type of tools being used for gripping or clamping a workpiece and has a pair of jaws, one movable and one fixed. In addition, they have a lever controlling a toggle mechanism which can retain the clamping or gripping force without requiring continuous holding by the hand. In operation, one type of the tool has the movable jaw being swung towards or away from the fixed jaw, resulting the jaws in angular configuration, and another type, the movable jaw is slid towards or away from the fixed jaw, resulting the jaws in parallelism during opening and closing thereof.

In 1997 O'Brien was granted an U.S. Pat. No. 5,644,960 for a toggle link hand tool having jaws of parallelism. He disposed an improvement over his tool by the so called “interchangeable head assembly”, each of which has a pair of jaws for different application readily attached, i.e., each pair of jaws is an integral part of the tool head.

However, O'Brien does not dispose the method of connecting the tool head to the tool body. From my humble judgement, when the tool heads are being interchanged, connection between the tool head and the tool body as well as that between the tool head and the toggle linkage would involve some sort of screw fastening, which could consume a certain amount of time and perhaps could even cause unwieldiness.

It is an object of this invention to modify wrench/pliers having jaws in parallelism to be able to employ sets of various kinds of jaws interchangeable for a wrench/pliers body to adapt different kinds of working requirements with a novel, quick and easy mechanism to exchange different pairs of jaws.

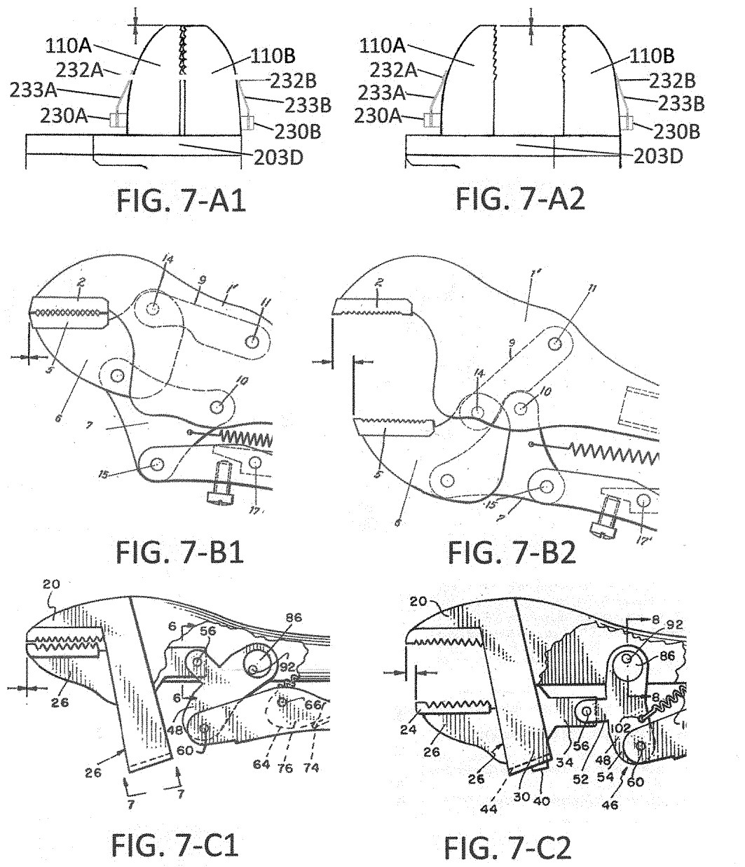

I have chosen a preferred embodiment of the wrench/pliers to develop my invention in the accompanying drawings within the scope of the appended claims. The type of embodiment chosen for the development of my invention must provide a pair of jaws which are sturdy in operation and can be maintained in parallelism during opening and closing thereof. Furthermore, the frontal edge of the movable jaw must be even with that of the fixed jaw within the range of the movable jaw. The meaning of this requirement is illustrated in FIGS. 7's. FIG. 7-A1 shows that the movable jaw of the chosen embodiment consistently keeps even with the fixed jaw within the movable range, as illustrated by FIG. 7-A2, whereas FIGS. 7-B1 through 7-C2 show that the movable jaws keep even with the fixed jaws only when they are in the closed configuration. Once the movable jaws are away from the fixed jaws, the former are always uneven with the latter.

### SUMMARY

The embodiment chosen for this invention belongs to the category of parallel jaws wrench/pliers. This invention uses the concept of “jaw-base” and “jaw-post” to secure the jaws. Details and advantages will be delineated in the following section of Detailed Description. The concept presents a “fixed jaw-post” being outstanding from one end of a tool body element and has a “movable jaw-post” being outstanding from a movable part which is slidable in a channel inside said tool body. Two parallel jaws of the tool are secured with these two “posts”, respectively, and they coact with each other. An action cam has a right corner being pivotally supported inside said tool body and has one top corner being connected to said movable part by special means which converts rocking movement into rectilinear translation that guides the movable jaw to coact with the fixed jaw. A left corner of the action cam is pivotally connected to an upper pivotal hole of a locking lever, which has a lower pivotal hole connecting to the respective upper ends of a fulcrum bar and a releasing lever simultaneously thereof.

A handle formed with hollow cross section is securely attached to said body element and has an end which is formed to accept an axially adjustable screw. Said axially adjustable screw has an engaging upper end and said fulcrum bar has an engaging lower end, and they are kept constantly engaged by means of a tension spring latching between said action cam and said handle. A guiding slot is machined at the lower portion of said handle to prevent against the side movement of said fulcrum bar during operation.

The locking lever, the fulcrum bar, and the axially adjustable screw constitute the basic toggle linkage, i.e., varying the axially adjustable screw will directly vary the distance between the jaws to accept the size of the workpiece. Close to the pivot of said releasing lever, there are two outstanding members disposed to respective opposite side walls thereof. When said pivot is forced by the locking lever to cross the toggle power line for a given work piece, this forward movement is stopped when said outstanding members hit the two respective edges of said handle, and the gripping/clamping action will stay locked.

When the releasing lever is gripped towards the handle, said two outstanding members will act as fulcrums to provide the releasing lever with leverage to force said pivot of the releasing lever to cross the toggle power line backward to its original relaxing condition, and the workpiece is released.

### DRAWINGS

### Figures

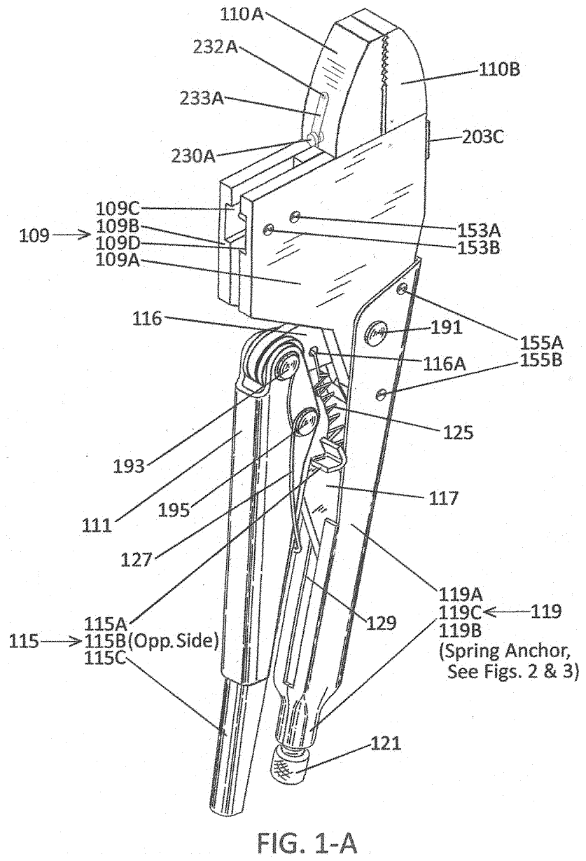

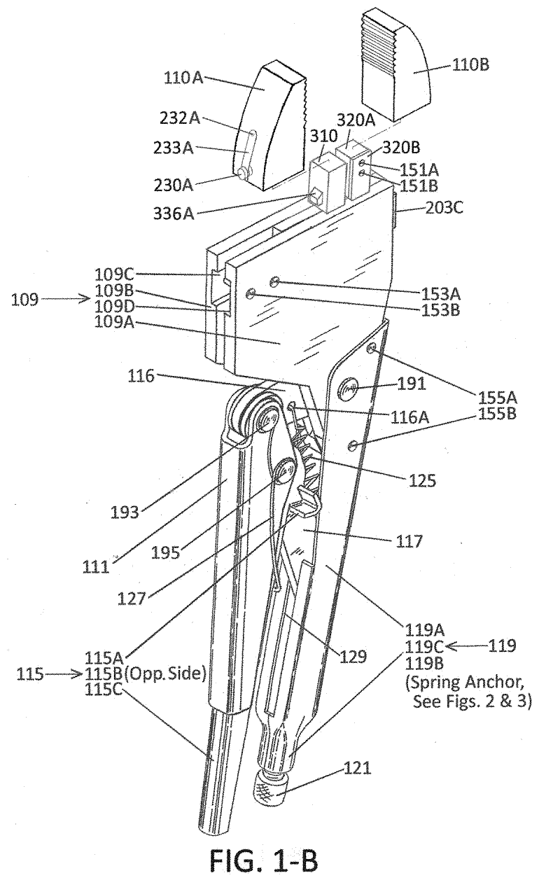

FIG. 1-A is an isometric view of the wrench/pliers. It shows the embodiment in the close jaw position.

FIG. 1-B is an isometric view of the wrench/pliers. It shows the “fixed jaw-post” and the “movable jaw-post”.

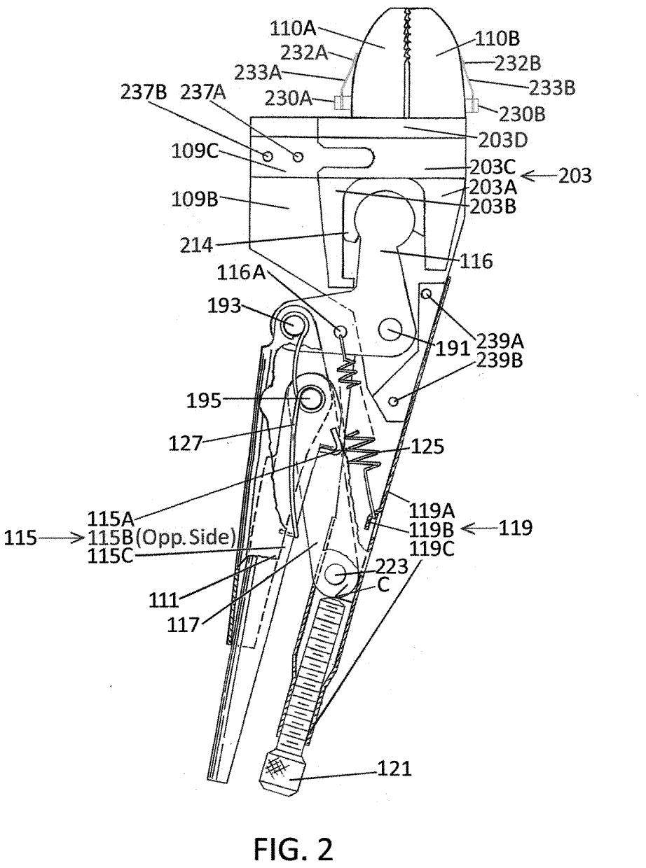

FIG. 2 is an exploded view of the embodiment in the close jaw position.

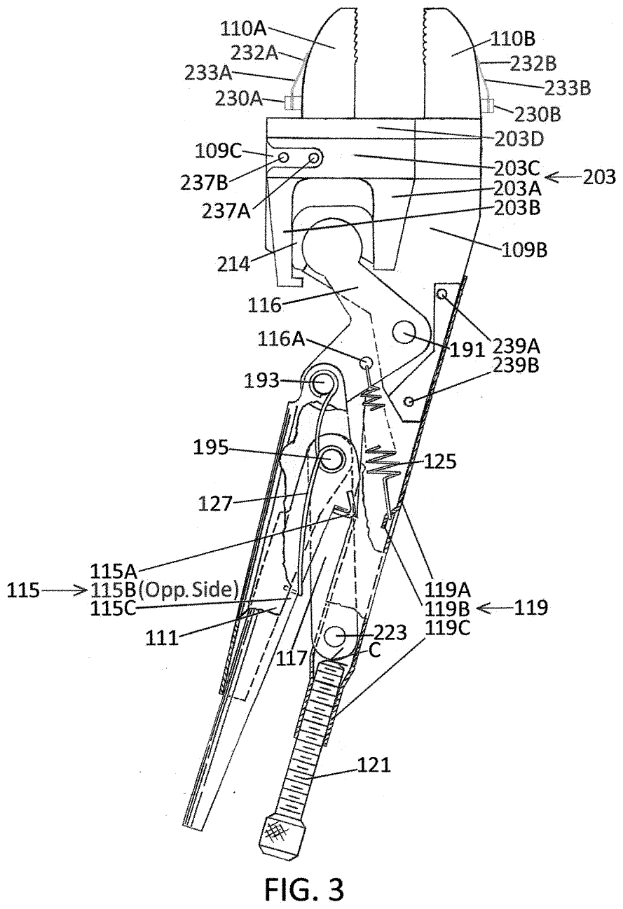

FIG. 3 is an exploded view of the embodiment in the open jaw position.

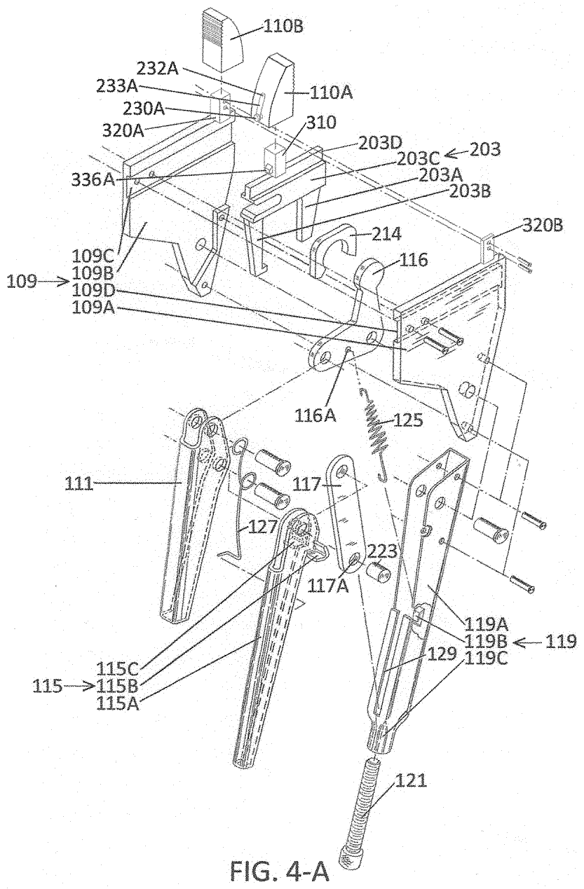

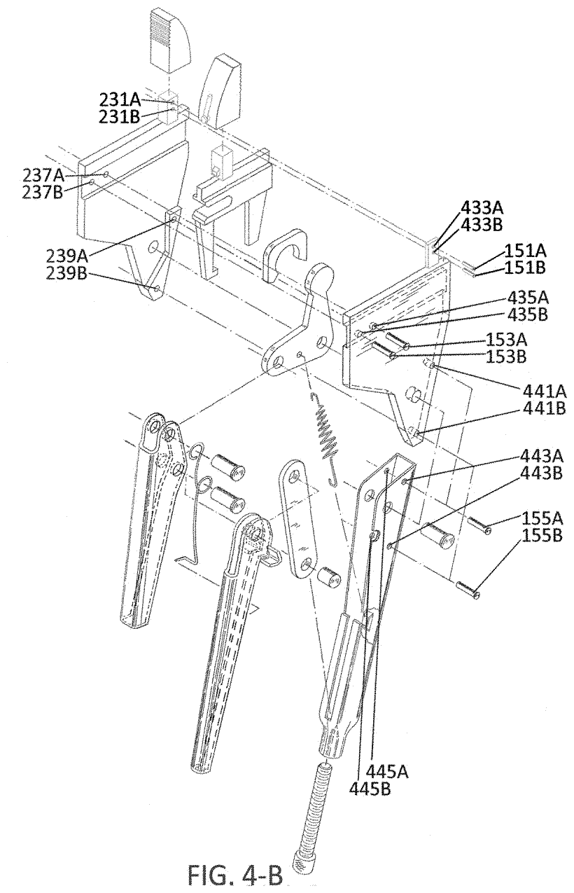

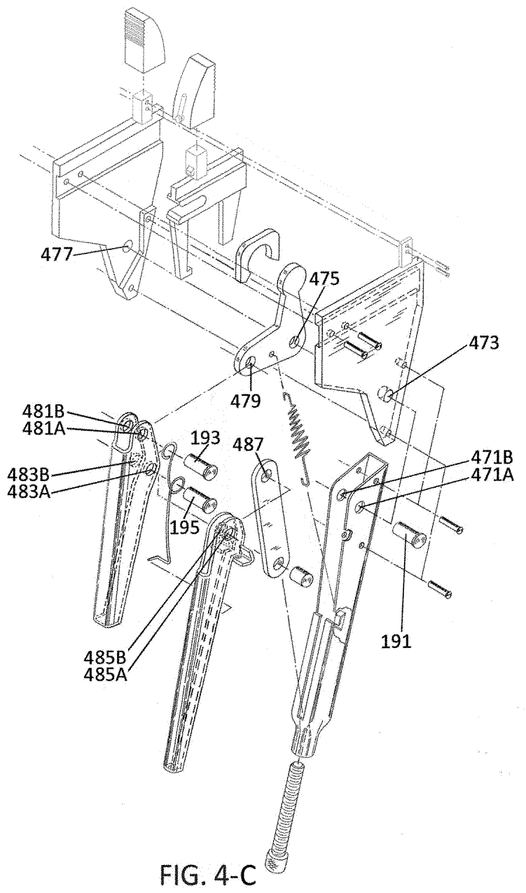

FIG. 4-A shows isometric views of all the parts of the embodiment. To avoid crowded labeling situation, only the parts are labeled in this drawing.

FIG. 4-B shows isometric views of all the parts of the embodiment. To avoid crowded labeling situation, only the fasteners and their corresponding holes are labeled in this drawing.

FIG. 4-C shows isometric views of all the parts of the embodiment. To avoid crowded labeling situation, only the pivotal pins and their corresponding holes are labeled in this drawing.

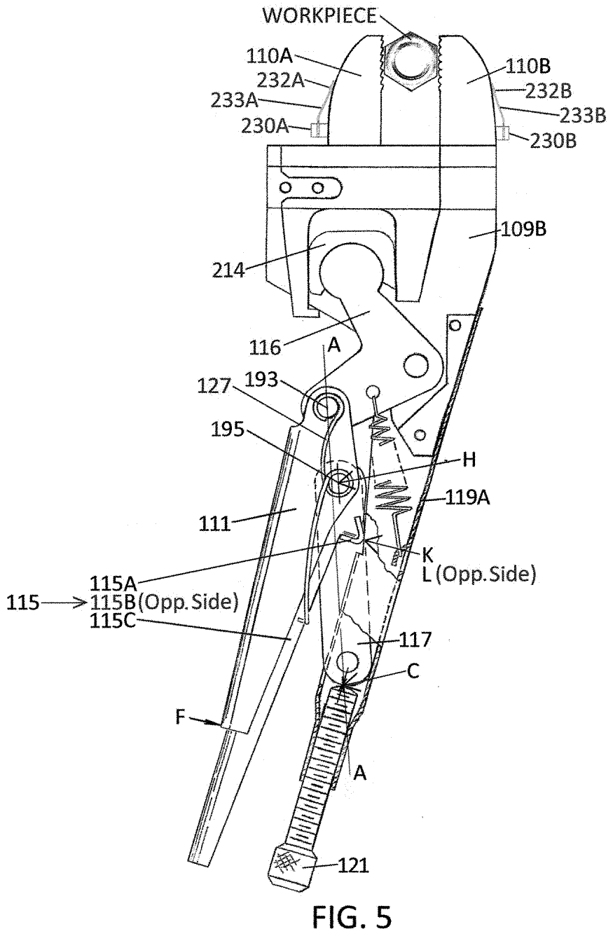

FIG. 5 is an exploded view of the embodiment in the locked configuration of gripping/clamping a workpiece.

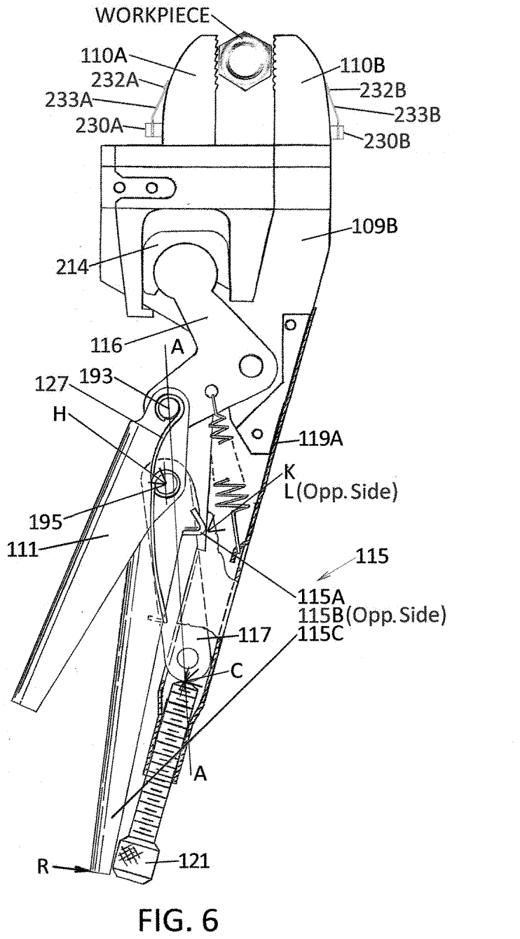

FIG. 6 is an exploded view of the embodiment in the unlocked configuration of releasing a workpiece.

FIGS. 7-A1 to 7-C2 show the meaning of even and uneven frontal edges of the movable jaws and the fixed jaws.

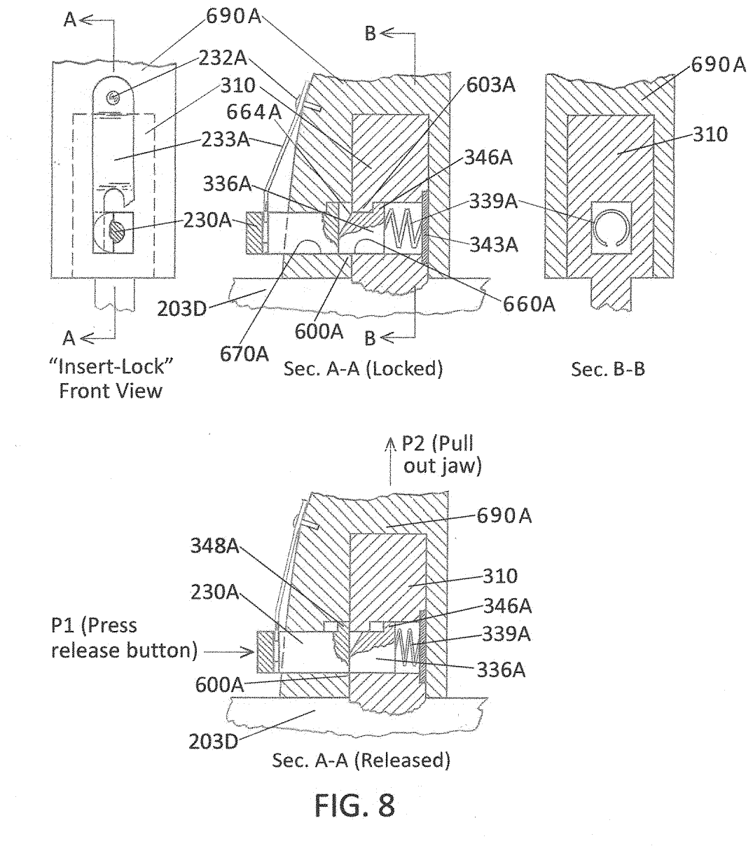

FIG. 8 shows the sections of the “jaw-base” and the “jaw-post” for illustrating the invention.

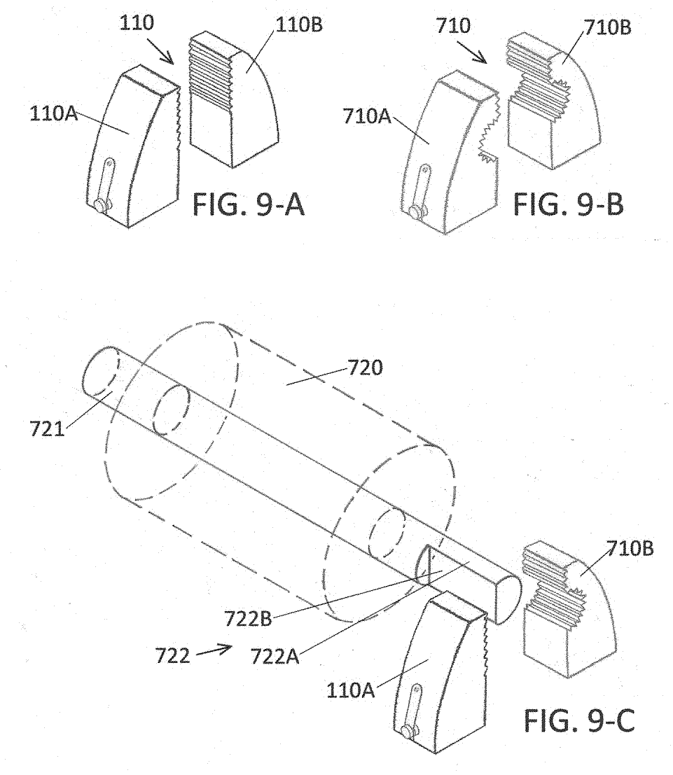

FIGS. 9-A to 9-C show two interchangeable jaw sets, flat working surface and crescent working surface, respectively. They also show the possibility of mixing interchange to form a third set with one jaw of each set for special application, demonstrating the versatility of the “jaw-base” and “jaw-post” concept.

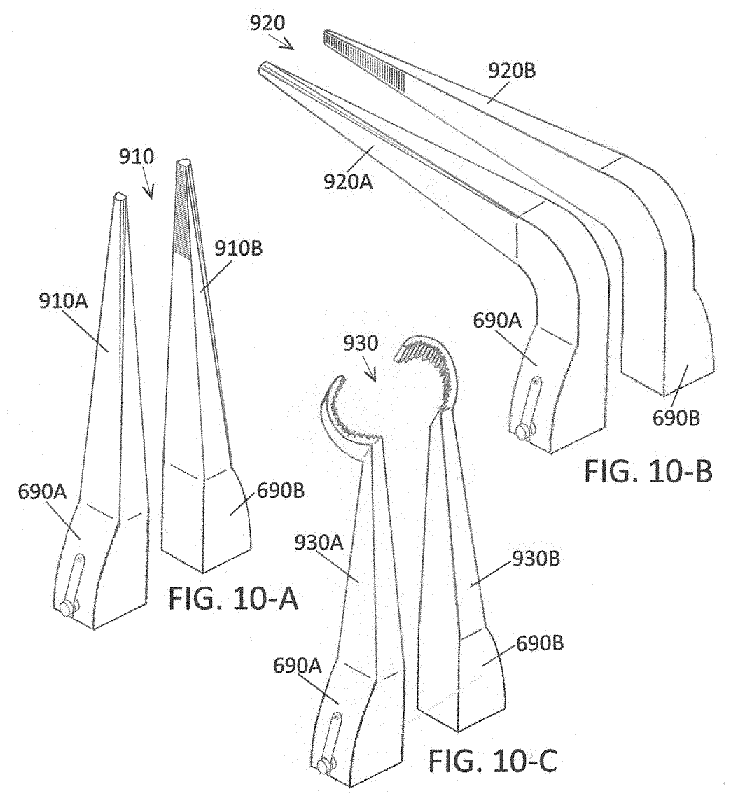

FIGS. 10-A to 10-C show three “long nose” sets for special applications.

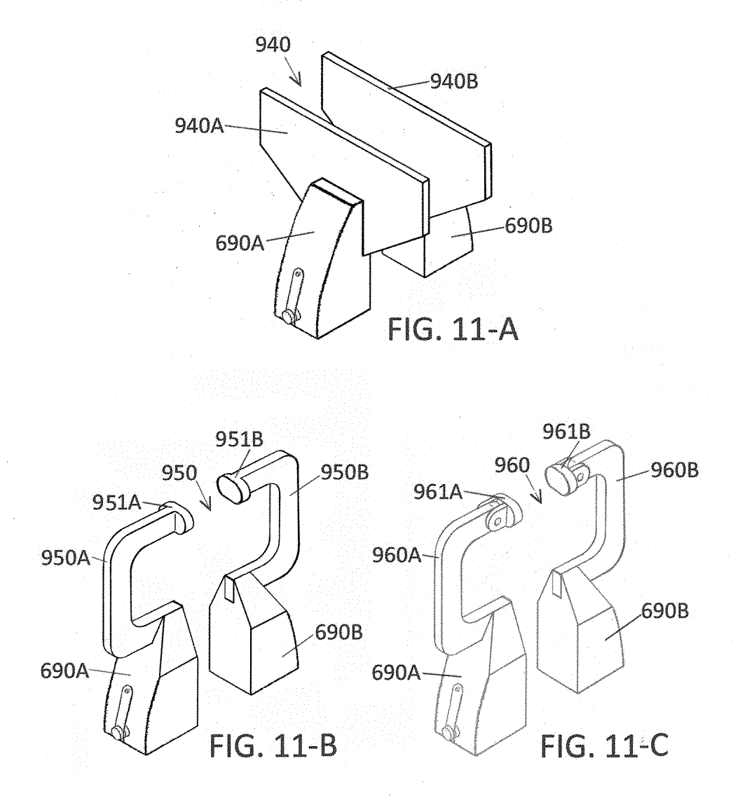

FIGS. 11-A to 11-C show other jaw sets for other possible applications.

### DETAILED DESCRIPTION

According to the comparison of hand tools on parallel jaws locking wrench/pliers shown in prior-art publications and on the markets, varieties of embodiments have illustrated different types of construction used to achieve the parallel-jaws configuration. And it is obvious that there should be some embodiments to provide a hand tool with parallel jaws that have “consistently even” jaw frontal edges (illustrated in FIGS. 7-A1 to 7-C2) and the jaws will not wave from side to side. Prior art shown by U.S. Pat. No. 5,644,960 issued to O'Brien seemed to have some ideal features. He proposed the concept of interchangeable tool heads to which jaws for special application were already attached. However, he did not explicitly describe how to connect the tool head to the tool body as well as the tool head to the toggle linkage during the interchanging process. This inventor suspects that the process might cause some unwieldiness. The concept of “jaw-base” and “jaw-post” proposed by this inventor can overcome this hurdle and provides other advantages of one or more features which will become obvious from the understanding of the following descriptions and accompanying drawings.

For clarity of illustration, the part numbers are shown in FIG. 4-A, the fastener numbers in FIG. 4-B, the pivotal pin numbers in FIG. 4-C, and element contact point labels in FIGS. 5 and 6. More part numbers are shown in FIG. 8.

This embodiment is a hand tool that functions as vise-grip wrench/pliers. The gripping/clamping function is performed by a fixed jaw 110B and a movable jaw 110A, both with serrated teeth, as shown by FIG. 1-A. These two jaws always maintain parallelism to each other within the travelling range of the movable jaw to provide a tight surface contact to a workpiece that has parallel opposite faces, e.g., a screw nut.

As indicated by FIG. 1-B, the “fixed jaw-post” and the “movable jaw-post” are used for securing the interchangeable jaw sets. The “fixed jaw-post” is formed by the combination of parts 320A and 320B. For illustration purpose, the jaws, respective, 110A and 110B are used to form the jaw set. Each jaw has a “jaw-base”, 690A for the movable jaw and 690B for the fixed jaw. And this set of “jaw-base” is the same for all jaw sets made for the same tool, because they have to match the same “movable jaw-post” and “fixed jaw-post”.

FIG. 8 is needed to help understanding how the “jaw-post” and the “jaw-base” work. The “jaw-base” is integrated with the jaw. A user only needs to insert the “jaw-base” directly over the “jaw-post”, the “jaw-post” latch 346A will immediately lock up the “jaw-base” firmly, and the wrench/pliers is now ready to be used.

If a user wants to disconnect a jaw from the “jaw-post”, he only needs to push the releasing button 230A on the “jaw-base” inward until it stops, and the jaw can be disconnected, or pulled up, from the “jaw-post”. All these simple and convenient operations are due to the simple mechanism shown by FIG. 8, where the “jaw-post” mechanism includes a latch 336A and a compression spring 339A which pushes the latch 336A outwards to lock. The latch 336A is normally in the locking position. Close to the lower end of the “jaw-post” is a channel 660A, which houses the latch 336A and the compression spring 339A. The locking end of the latch has a sloping surface 664A. When the “jaw-base” is being inserted over the “jaw-post”, the lower end of the “jaw-base” will glide over the sloping surface 664A and will force the latch 336A to retreat into the channel 660A to allow the “jaw-base” to pass over. The “jaw-base” has a channel 670A close to the bottom of the base and is at the same elevation of the “jaw-post” channel 660A housing the latch 336A. The pushing end of the releasing button is constrained by a leaf spring 233A, which keeps the pushing end of the releasing button in the outward position. When the releasing button is being pushed inward, the end of the releasing button inside the channel will push the latch inward until the end of the button is stopped by a shoulder 348A and is flush with the wall of the “jaw-post”. This means that the locking end of the latch is also flush with the wall of the “jaw-post”. This means there is now nothing blocking the “jaw-base” being pulled away from the “jaw-post”, and the wrench/pliers is ready to accept another jaw set, if it is needed.

FIGS. 2 and 3 illustrate the rectilinear sliding motion of the movable jaw 110A, which is imposed by the rocking movement of an action cam 116 through an interface 214 that slides between the inside parallel opposing edges of the right tapered bar 203A and the left tapered bar 203B.

The movement of the movable jaw 110A is guided by movable part 203C, which is sandwiched between a channel 109C and a channel 109D, as shown by FIG. 4-A.

The complete wrench/plier body is composed of two body matching parts, namely, a body matching part 109A (thin fixed jaw side) and a body matching part 109B (thick fixed jaw side), as shown by FIG. 1. They are configured to house the parts 203A to 203C, the interface 214, and the action cam 116 when they are assembled and secured by binders 151A, 151B, 153A, 153B, 155A and 155B, as shown by FIG. 4-B.

As shown by the exploded views FIGS. 2 and 3, the action cam 116 is pivoted inside the body housing described above by means of a pivotal hinge pin 191. It is also pivotally connected to a locking lever 111 by means of a hinge pin 193. The locking lever 111 is also pivotally connected to a fulcrum bar 117 by means of a hinge pin 195. The fulcrum bar 117 is partially concealed inside the wrench/plier handle 119A and is constantly engaged with an axially adjustable element 121 at the contact location C, as illustrated by FIGS. 2 and 3.

The handle 119A is formed with a piece of sheet metal into a channel cross-section for strength. The end of the handle 119A is formed into a tube 119C, which has internal threats to accept a screw 121. A guiding slot 129, shown by FIG. 1, allows the fulcrum bar 117 to travel according to the adjustment of the screw 121, as shown by FIG. 4-A.

The tension spring 125 is used to keep the fulcrum bar 117 consistently engaging with the upper end of the element 121 at location C. This arrangement constrains the moving jaw 110A to travel consistently according to the adjustment of the screw 121.

A spring wire 127 of the releasing lever 115C is used to keep the releasing lever 115C to always remain within the locking lever 111 to avoid the undesirable swinging movement of the latter during the usage of the tool.

As shown by FIG. 4-A, the releasing lever 115C has two outstanding members 115A and 115B formed at the two opposite sides, respectively. Their functions are explained in detail in the OPERATION section.

### DRAWINGS

### Reference Numerals

### (Refer to FIG. 4-A)

109 group number for the channel group 109A, 109B, 109C, and 109D
109A body matching part (thin fixed jaw side)
109B body matching part (thick fixed jaw side)
109C channel wall (thick fixed jaw side)
109D channel wall (thin fixed jaw side)
110A movable jaw
110B fixed jaw
111 locking lever
115 group number for the releasing lever group 115A, 115B, and 115C
115A releasing lever
115B outstanding member (near side)
115C outstanding member (far side)
116 action cam
116A tension spring anchoring hole
117 fulcrum bar
117A fulcrum bar stopper hole
119 group number for the handle group of 119A, 119B, and 119C
119A handle
119B tension spring anchor
119C end of handle
121 axially adjustable screw
125 tension spring
127 spring wire of releasing lever
129 guiding slot
203 group number for 203A, 203B, 203C, and 203D
203A right tapered bar
203B left tapered bar
203C movable part
203D upper movable part
214 interface
223 stopper
230A left releasing button
232A left leaf spring rivet
233A left leaf spring
310 left jaw post
320A right jaw post (thick one)
320B right jaw post (thin one)
336A left latch

### (Refer to FIG. 4-B)

151A right jaw-post upper fastener
151B right jaw-post lower fastener
153A channel right fastener
153B channel left fastener
155A handle upper fastener
155B handle lower fastener
231A thick fixed jaw-post upper fastener hole
231B thick fixed jaw-post lower fastener hole
237A thick fixed jaw channel right fastener hole
237B thick fixed jaw channel left fastener hole
239A thick fixed jaw body matching part upper fastener hole
239B thick fixed jaw body matching part lower fastener hole
433A thin fixed jaw-post upper fastener hole
433B thin fixed jaw-post lower fastener hole
435A thin fixed jaw channel right fastener hole
435B thin fixed jaw channel left fastener hole
441A thin fixed jaw body matching part upper fastener hole
441B thin fixed jaw body matching part lower fastener hole
443A handle upper fastener hole (near side)
443B handle lower fastener hole (near side)
445A handle upper fastener hole (far side)
445B handle lower fastener hole (far side)

### (Refer to FIG. 4-C)

191 action cam pivotal hinge pin
193 locking lever pivotal hinge pin
195 fulcrum bar pivotal hinge pin
471A handle pivotal hole (near side)
471B handle pivotal hole (far side)
473 body matching part pivotal hole (thin fixed jaw)
475 action cam pivotal hole
477 body matching part pivotal hole (thick fixed jaw)
479 action cam-to-locking lever pivotal hole
480A spacer pivotal hole (near side)
480B spacer pivotal hole (far side)
481A locking lever upper pivotal hole (near side)
481B locking lever upper pivotal hole (far side)
483A locking lever lower pivotal hole (near side)
483B locking lever lower pivotal hole (far side)
485A releasing lever pivotal hole (near side)
485B releasing lever pivotal hole (far side)
487 fulcrum bar pivotal hole

### (Refer to FIG. 5 and FIG. 6)

C contact point between lower end of fulcrum bar and upper end of adjustable screw
H center of fulcrum bar pivotal hinge
K contact point between outstanding member and handle
L contact point between outstanding member and handle (Opp. Side)

### (Refer to FIG. 8)

203D upper movable part
230A left releasing button
232A left leaf spring rivet
233A left leaf spring
310 left “jaw-post”
336A left latch
339A compression spring
343A back plate
346A latch stopper
348A releasing button stopper
600A “jaw-base” upper
603A “jaw-post” stopper
660A “jaw-post” channel
664A latch sloping front surface
670A “jaw-base” channel
690A “jaw-base”
P1 force pressing releasing button
P2 force pulling out “jaw-base”

### (Refer to FIGS. 9-A to 9-C)

110 Group number for jaw set 110
110 A movable jaw with flat working surface containing corrugated teeth
110B fixed jaw with flat working surface containing corrugated teeth
710 group number for jaw set 710
710A movable jaw with crescent working surface containing corrugated teeth
710B fixed jaw with crescent working surface containing corrugated teeth
720 rotor of electric motor
721 shaft of rotor
722 group number of end configuration of shaft of rotor
722A circular profile of the end of the shaft
722B flat face profile of the end of the shaft

### (Refer to FIGS. 10-A to 10-C)

690A jaw-base for movable jaw
690B jaw-base for fixed jaw
910 group number for jaw set 910
910A movable jaw with pointed nose working surface containing corrugated teeth
910B fixed jaw with pointed nose working surface containing corrugated teeth
920 group number for jaw set 920
920A movable jaw with 90° pointed nose working surface containing corrugated teeth
920B fixed jaw with 90° pointed nose working surface containing corrugated teeth
930 group number for jaw set 930
930A movable jaw with crescent working surface containing corrugated teeth
930B fixed jaw with crescent working surface containing corrugated teeth

### (Refer to FIGS. 11-A to 11-C)

690A jaw-base for movable jaw
690B jaw-base for fixed jaw
940 group number for jaw set 940
940A movable jaw with metal plate for forming sheet metal work
940B fixed jaw with metal plate for forming sheet metal work
950 group number for jaw set 950
950A movable jaw with C-clamp arm containing fixed working surface 951A
950B fixed jaw with C-clamp arm containing fixed working surface 951B
960 group number for jaw set 960
960A movable jaw with C-clamp arm containing hinged working surface 961A
960B fixed jaw with C-clamp arm containing hinged working surface 961B

### Operation

The object of this invention is to originate a toggle control wrench/pliers that can manipulate simple and effective interchangeable jaw sets. To follow this object, we will begin by going through the jaw set management. Since the interchangeable jaw set system includes many different sets, or different pairs, of jaws, the purpose of the work or the procedure of doing the work must be understood first. As I have mentioned before that the system does not restrict using jaws of the same set, it allows the choice of intermixing of different sets, like the example illustrated by FIGS. 9-A through 9-C, to do the work most effectively. Once we have gone through this procedure, we can simply insert the “jaw-base” of the selected jaws over the “jaw-post” to complete the wrench/pliers tool and start the work. We select jaw set 110 for illustrating the current embodiment.

For the current embodiment (refer to FIGS. 2 and 3), the open jaw distance required for the size of a workpiece is achieved by adjusting an axially adjustable screw 121. The adjustment causes a rocking motion on an action cam 116 through the connection of a locking lever 111 by means of pivotal hinge pins 193 and 195, which connects to a fulcrum bar 117. The lower end of said bar 117 has constant engagement with the upper end of said screw 121. By means of the configuration of an interface 214 and its movement between the opposing parallel edges of a right tapered bar 203A and a left tapered bar 203B, the rocking motion of said cam 116 imposes a rectilinear movement on a movable part 203C sliding in a channel 109 to carry a movable jaw 110A to press the workpiece against the fixed jaw 110B.

When a gripping force F is applied to the locking lever 111 towards the handle 119A, as shown by FIG. 5, a clamping force on the workpiece is generated when the center H of pivotal connection pin 195 of fulcrum bar 117 is pushed to the position of the power line A-A (shown by FIG. 5 as a straight line defined from the center of hinge pin 193 to the engaging point C of said bar 117 and said screw 121. The line A-A is termed power line because the workpiece will experience maximum clamping/gripping force when the center point H of said hinge pin 195 is at this line. If said applied force F pushes the center point H further to pass the power line A-A, said point H will be stopped when two outstanding members 115A and 115B touch the respective edges of the handle 119A at point K and point L (opp. side), as shown by FIG. 5. At this configuration of the embodiment, the tight clamping/gripping onto the workpiece is achieved and is securely locked without requiring any further hand gripping assistance from the hand.

When the workpiece is to be released, the user can apply a force R to the releasing lever 115C towards the handle 119A, as shown by FIG. 6. The two members 115A and 115B now together act as a fulcrum to provide leverage to the releasing lever 115C, and the center point H will be pushed to cross the power line A-A back to its originally unclamped position, and the clamping action on the workpiece is thus entirely released.

If the user wants to use another set of jaws, he can simply press the releasing buttons 230A (refer to FIG. 8) and 230B (not shown) to release the jaw set 110 and insert another jaw set for another work.

### CONCLUSION

According to the foregoing detailed description, it can be seen that the features of current parallel jaws locking wrench/pliers are enhanced by employing the “jaw-base” and “jaw-post” concept, rendering the said ordinary wrench/pliers a reliable and versatile hand tool.

I claim:

1. A parallel jaws locking wrench/pliers with toggle action, comprising:
a. a body element being constructed with two body matching parts being bound together with screws,
b. an outstanding “fixed jaw-post” being disposed upward from the right top corner of said body element,
c. a channel, having a length equal to the width of said body element and being under said “fixed jaw-post”, being disposed between said body matching parts,
d. a void, having a sufficient volume to allow the rocking movement of an action cam and the simultaneous translation movement of a left tapered bar and a right tapered bar, being formed between said body matching parts and being under and communicating with said channel,
e. an outstanding “movable jaw-post” being integral of and being disposed upward from the “left midsection” of a movable part having cross sectional dimensions equal to those of said channel and being freely slidable in said channel,
f. said left tapered bar and said right tapered bar being respectively extended vertically downward from the two respective ends of said movable part into said void, a right edge of said left tapered bar and a left edge of said right tapered bar being straight and parallel to each other, allowing an interface being freely slidable therebetween,
g. a right side lower corner of said action cam being pivotally supported inside said void; a top corner of said action cam being pivotally connected with proper means to said movable part to effect the translational movement of said “movable jaw-post”; a left side lower corner of said action cam being pivotally connected to an upper pivotal hole of a locking lever,
h. a handle being formed to have a cross section of channel shape and being securely attached to said body element with screws and it having a lower end being equipped with internal threads to accept an axially adjustable screw,
i. a fulcrum bar having a lower end being kept constantly engaged with the upper end of said axially adjustable screw by a tension spring connected between said action cam and said handle,
j. the lower pivot hole of said locking lever, the pivot hole of a releasing lever, and the pivot hole at the upper end of said fulcrum bar being journaled by one pivot,
k. two outstanding elements being disposed close to the pivot of said releasing lever and to the respective opposite outside walls of said releasing lever,
l. the upper end of a length of spring wire being anchored by the upper and the lower pivots of said locking lever, and
m. the lower end of said spring wire being held against the releasing lever, preventing the releasing lever from unintentionally swinging out of the locking lever during operation.

2. A wrench/pliers as set forth in claim 1, wherein said top corner of said action cam being connected to said moving part with proper means comprising creating an inner circular opening in said interface and a corresponding outside circular profile around said top corner of said action cam to match each other so that a pivotal connection is created, converting a rocking movement of said action cam to a linear translation of said moving part and the “movable jaw-post”.

3. A wrench/pliers as set forth in claim 1, wherein the “fixed jaw-post” and the “movable jaw-post” are used for securing the interchangeable jaw sets.

4. A wrench/pliers as set forth in claim 1, wherein each jaw set has two jaws, one is the fixed jaw and the other one is the movable jaw.

5. A wrench/pliers as set forth in claim 1, wherein each jaw set is specially formed to have special configuration for one or more specific applications.

6. A wrench/pliers as set forth in claim 1, wherein due to two body matching parts being used to construct the tool body, the “fixed jaw-post” is formed with two matching parts accordingly.

7. A wrench/pliers as set forth in claim 4, wherein each jaw has a “jaw-base” being integrated with the jaw. A user only needs to insert the “jaw-base” directly over the “jaw-post” and the “jaw-post” latch will immediately lock up the “jaw-base” firmly, and the wrench/pliers is then ready to be used.

8. A wrench/pliers as set forth in claim 7, wherein a user can disconnect a jaw from the “jaw-post” by pushing a release button on the “jaw-base”, and he can immediately disconnect the jaw from the tool.

9. A wrench/pliers as set forth in claim 7, wherein the “jaw-post” locking mechanism includes a latch and a compression spring which pushes the latch outward to lock. The latch is normally in the locking position. Close to the lower end of the “jaw-post” is a channel which is parallel with said moving part. This channel houses the latch and the compression spring. The locking end of the latch has a sloping surface. When the “jaw-base” is being inserted over the “jaw-post”, the lower end of the “jaw-base” will glide over the sloping surface and force the latch to retreat into the channel to allow the “jaw-base” to pass over.

10. A wrench/pliers as set forth in claim 9, wherein the “jaw-base” has a channel close to the bottom of the base and is at the same elevation of the “jaw-post” channel housing the latch. The pushing end of the button is constrained by a leaf spring which keeps the pushing end of the button in the outward position. When the button is being pushed inward, the end of the button inside the channel will push the latch inward until the end of the button, and hence the front end of the latch, is flush with the wall of the “jaw-post”. At this moment the user is able to slide the “jaw-base” away from the “jaw-post”

11. A wrench/pliers as set forth in claim 1, wherein each jaw of the selected set comprises a “jaw-base” for easy interchange and a flat working surface with corrugated teeth for firm ripping/clamping on the workpiece.

12. A wrench/pliers as set forth in claim 1, wherein each jaw of the selected set comprises a “jaw-base” for easy interchange and a crescent working surface with corrugated teeth for firm gripping/clamping circular workpiece.

13. A wrench/pliers as set forth in claim 1, wherein each jaw of the selected set comprises a “jaw-base” for easy interchange. One jaw is selected from the set that has a flat working surface with corrugated teeth; the other jaw is selected from the set that has a crescent working surface with corrugated teeth. This combination is useful for gripping/clamping, e.g., the shaft of the rotor of an electric motor. Quite often the rotor shaft has one end with partial flat face for jamming the step pulleys securely. It may be convenient with this jaw combination holding this end for better security when working with this type of workpiece.

14. A wrench/pliers as set forth in claim 1, wherein each jaw of the selected set comprises a “jaw-base” for easy interchange and a pointed nose tip with corrugated teeth, said jaw set being good for reaching narrow spaces to pick up small pieces.

15. A wrench/pliers as set forth in claim 1, wherein each jaw of the selected set comprises a “jaw-base” for easy interchange and 90° pointed nose tip with corrugated teeth. Some clamped spaces will need to work with tools of such configuration.

16. A wrench/pliers as set forth in claim 1, wherein each jaw of the selected set comprises a “jaw-base” for easy interchange and a long narrow nose with a crescent tooth set at the nose tip, said jaw set being useful in pulling out objects such as electrical bundles or rubber water hoses for car services or similar situations.

17. A wrench/pliers as set forth in claim 1, wherein each jaw of the selected set comprises a “jaw-base” for easy interchange and a wide metal plate, said jaw set being useful for bending or forming sheet metal objects.

18. A wrench/pliers as set forth in claim 1, wherein each jaw of the selected set comprises a “jaw-base” for easy interchange and a c-clamp arm with fixed small working surface, said jaw set being versatile in clamping objects of various sizes.

19. A wrench/pliers as set forth in claim 1, wherein each jaw of the selected set comprises a “jaw-base” for easy interchange and a c-clamp arm with hinged working surface, said jaw set being useful in clamping objects having non-parallel or slightly irregular clamping surfaces.
Whereby the concept of using jaw-posts and jaw-base provides convenient and economical ways to perform works. It is convenient because a user only needs to carry one wrench/pliers body (it is obvious that transportation weight and tool cost are greatly reduced.); it is economical because a user only needs to buy selected jaw sets to serve his purposes (it is obvious that a selected collection of jaw sets is far cheaper than a collection of complete wrench/pliers which includes both tool bodies and jaws.) In addition, it only takes one step to engage the selected jaw to the tool body and only one step to disconnect the jaw from the tool body.
